(19) United States
(12) Patent Application Publication
(10) Pub. No.: US 2010/0312658 A1
(43) Pub. Date: Dec. 9, 2010

(54) MULTIFUNCTION CUSTOMER STATION SYSTEM

(76) Inventor: Joan Lloveras Calvo, Sant Feliu De Codines (ES)

Correspondence Address: BANNER & WITCOFF, LTD., 1100 13th STREET, N.W., SUITE 1200, WASHINGTON, DC, 20005-4051, US

(21) Appl. No.: 12/509,823

(22) Filed: Jul. 27, 2009

(30) Foreign Application Priority Data
Jun. 5, 2009 (ES) 200901369

(51) Int. Cl. G06Q 30/00; G06Q 50/00

(52) U.S. Cl. 705/17

(57) ABSTRACT

The system comprises a central computer or server responsible for the management and connection of a multiplicity of multifunction stations or terminals which interact with each of the customers, as well as managing connections with the exterior, and storing and controlling a series of applications which permit the multifunctionality to be applied to all the customer stations; the multifunction station basically consists of a touch screen and loudspeakers, a card reader, connectors of all types, a camera which permits the station to execute a multiplicity of functions such as viewing films, selecting from a restaurant menu, charging a mobile telephone, access to payment locations on internet, establishment of video calls, visualisation of information stored in another support and connected through a multiplicity of connectors etc.

### OBJECT OF THE INVENTION

The object of this invention is a system of multifunction customer stations clients, which, as the title of the invention indicates, is provided with various stations having a number of functions which makes it specially versatile and useful, and which is applicable to all those premises, areas and locations in which the client wishes or is obliged to spend time, thus obtaining a multiplicity of functionalities in an integrated manner in a single arrangement which results in facilities for clients and which, in addition, permits them, in addition to remaining in said location either out of necessity or choice, to carry out other activities either in an individual or shared manner. Said activities may be entertaining or directly related to work.

The present invention is characterised by the special configuration and design of the elements comprising the multifunction customer station which is the object of the invention, which makes it especially practical, versatile and of practical use in a number of situations involving both work and leisure.

Therefore, this invention is circumscribed within the scope of the systems and means which will permit access to a variety of services from a customer station.

### BACKGROUND TO THE INVENTION

To date there are numerous publications proposing a system for carrying out remote control commands from a restaurant table using a touch screen from which the user is able to make his own order. Said commands or orders are transmitted to a central computer where they are processed, thus obviating the need for any additional intervention from a waiter.

Nevertheless, despite the fact that this functionality is practical from an operational point of view, there are some aspects which require improvements, as the intention is to provide more than simply enabling a connection to be established with a central computer of commands or orders.

The purpose herein is to obtain a multifunction customer station, which offers a multiplicity of functions, including that of making a remote order without the assistance of a waiter.

Coin-operated games machines are also known, such as those found in some bars and restaurants. These games machines are bulky, they take up space, and are susceptible to theft, they are also noisy and do not protect the user or player's privacy, and they also require coins in order to play.

Similarly, in bars and restaurants, films or matches are often shown which are simultaneously watched by all customers, with no privacy in viewing, and where furthermore, there is no choice regarding viewing which is communally shared with all the clientele present.

On other occasions, in public places members of the public are provided with the means for accessing internet or consulting their e-mails, with these means being those which provide all the resources of a computer per station, with the concomitant use of space and costs of these resources made available to the customer or user.

Now with this invention a synergic effect is sought, which will overcome the disadvantages of all the forms of execution proposed, namely space, safety of privacy, noise and which will permit the possibility of combining in a single system all the aforementioned functionalities.

### DESCRIPTION OF THE INVENTION

The purpose of the invention is a multifunction customer station which permits the possibility of carrying out a multiplicity of functions by the user or customer of premises using a touch screen.

The system basically consists of a central computer which manages and connects with a multiplicity of terminals interacting with each customer, as well as the management of connections with the exterior, it also stores and controls a series of applications which permit the realisation of the multifunctionality with which it is proposed to provide each of the customer stations.

As mentioned, the central computer or server establishes a communication with each of the multifunction stations through touch screens, and is able to provide them with the service they require. Furthermore, said central computer also communicates with the exterior permitting access to networks such as internet.

The multifunction station basically consists of a touch screen and a series of additional elements which permit execution of a multiplicity of functionalities. The touch screen is also provided with a hard disk and a microcontroller. The hard disk among other functionalities permits storing and recording of all the information relating to the actions carried out in each multifunction station, while the microcontroller controls and governs all the peripheral elements associated with a multifunction station, as well as communicating with the central computer.

The elements integrated jointly with the touch screen include:
Loudspeakers and associated means for volume regulation.
Credit card reader
USB and HDMI connectors, and any other type of connector which permits interconnection with any type of electronic device which will permit data capture from the multifunction station.

As a result of the synergy of the elements which make up the multifunction station system, that is, the characteristics of the central computer and each of the multifunction stations which basically consist of touch screens associated with peripheral hardware, a series of functionalities are obtained, such as those described below:
on one hand each of the multifunction customer stations is provided with a magnetic band card reader and a card payment application which resides in the central computer, and which permits payment which is charged to the card. Said payment may correspond to the consumption made or the amount spent on a game, the application of which resides in the central application.
Due to the software applications residing in the multifunction customer station system's central computer, the customer is able to select a number of options.
   Viewing a menu
   Selecting and ordering from a menu
   Payment by card
   Access to external information (e-mail, navigation)
   Playing games of chance
   Requesting viewing of a film, or a football match or any other free or paid broadcast
   Playing children's games
   Varied information on travel, hotels and bookings
   Access to internet in order to navigate freely with the blocking means appropriate to the premises.
   Setting up video conferences
   Recharging mobile telephone cards
Due to the control carried out at the system's central computer, it is possible to have controlled access at each of the multifunction customer stations to which access is obtained by means of a previously allocated code.
Due to the multiplicity of external connectivity elements it is possible to access information stored in a CD, in a DVD, pen drive or massive information storage means, such as a hard disk or multimedia hard disk.

The multifunction station system which is the subject of this invention in addition to providing a number of versatile functions, is also versatile from the perspective of places where it is used, such as restaurants, waiting rooms, (airports railway stations,) in ships, in buses and in hotel rooms.

Due to the system which is the subject of the invention it has been possible to overcome technical difficulties, as until the present, in addition to the impossibility of carrying out similar functionalities it was necessary for each person to bring their lap top computer and using this carry out tasks such as gaining access to information through internet or working on files, or consulting e-mails.

Now, as a result of the multifunction station system which is the subject of this invention, it is possible to carry out all the activities which to date could only be performed with a lap top, without any need to carry the lap top computer which clearly makes life easier for the user and reduces final costs, as there is no need to provide a lap top for each station which is to be provided with multifunctionality.

### DESCRIPTION OF THE FIGURES

In order to complete the description below, and to assist in obtaining a better comprehension of its characteristics, the present descriptive report is accompanied by a set of plans with figures representing in an illustrative but not restrictive way the most significant details of the invention.

FIG. 1 shows a representation of the elements of which the multifunction customer station is composed.

FIG. 2, shows a detailed diagram of the features and elements integrated in each of the multifunction stations.

### PREFERRED EMBODIMENT OF THE INVENTION

In the light of the figures below, a preferred embodiment of the proposed invention is described.

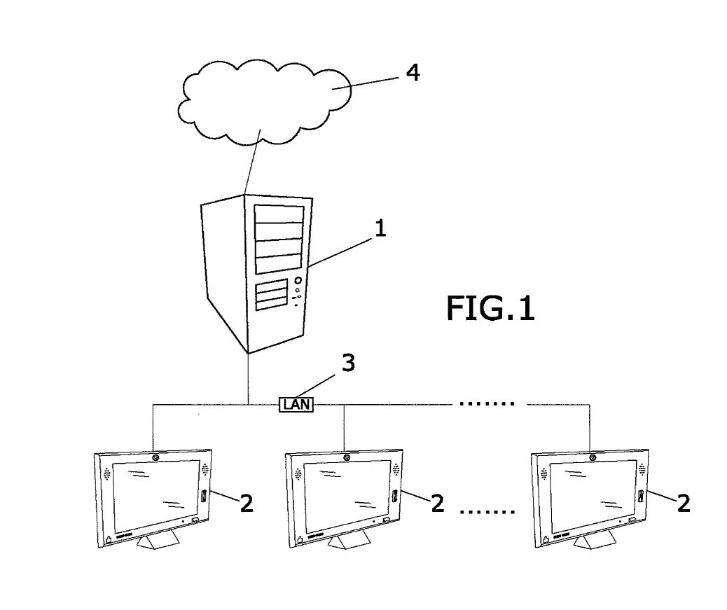

FIG. 1 shows how the multifunction customer station system basically comprises a central computer or server (1) and a series of multifunction stations (2) which in turn include at least one touch screen provided with a series of connections for access to information.

The central computer (1) is connected either point to point or using a LAN network (3) with all the multifunction stations (2).

The central computer (1) is where all the applications required by each of the multifunction stations reside, as well as being responsible for communication with the exterior via internet (4) for example. The central computer is responsible for communication with a server which is provided with all the resident applications such as network or web applications.

Thus, due to the fact that it is only one central computer which is responsible for running all the applications to which there is access from each of the multifunction stations, there is a saving in management capacity. This central computer (1) runs applications such as selection and ordering from a menu, requesting the restaurant bill, payment of items consumed, request to view a film, request for games of chance, casino or children's games, connection with a possible printer, recharging mobile telephones, access to e-mail accounts, reception of mail, as well as visualisation of information supplied by any of the multiple access ports, for which reason it is provided with all types of connectors and means of access to information.

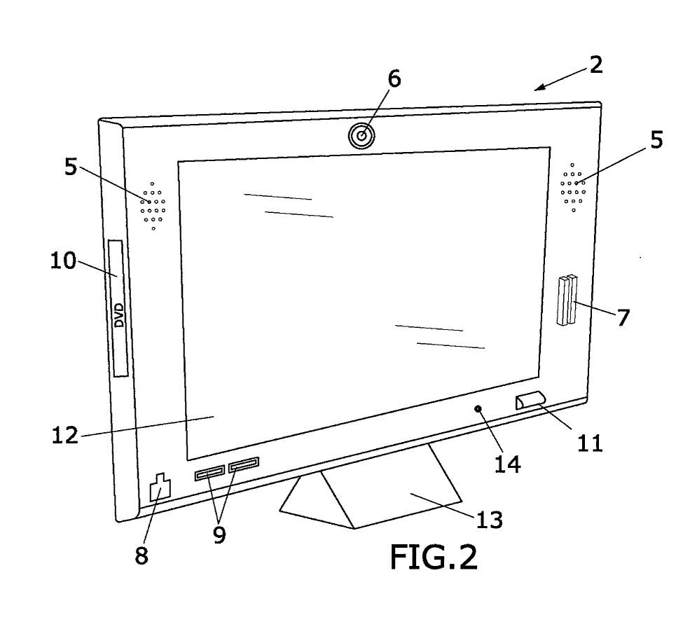

FIG. 2 shows some of the constructive characteristics provided by multifunction posts (2) which basically consist of a touch screen (12) on which various elements have been incorporated, such as for example, loudspeakers (5), which permit audition of multimedia documents such as videos and films or games with sound. In the event that it is wished to listen to said documents without disturbing persons in the vicinity a head phone connection is provided.

Each of the multimedia stations is provided with a hard disk and a microcontroller, which stores and reads the data recorded, as well as controlling the associated peripheral elements and communications with the central computer.

It is also provided with a camera (6) in order to set up video conferences. The multifunction station is provided with a card reader (7) in order to establish payments by reading the magnetic band of a card.

In order to visualise any type of information supplied from another physical support, each multifunction station (2) is provided with a variety of connectors of all kinds having represented the most common, such as USB connectors (9) network connector (9) or HDMI connector. The information may also be transmitted to and from the computer using a Bluetooth connector. It is also provided with a DVD reader (10) for viewing any information contained in said support.

The multifunction station (2) is provided with a fixation support (13) which can be oriented and tilted, which permits the array to adapt to the most appropriate position for the customer, or customers if shared among several.

The multifunction station (2) therefore, in the case of a restaurant would be arranged on one side of the table itself, or either affixed to a wall if the table is set against the wall, or suspended from the ceiling. In the event of integration in passenger seats, it may be affixed on the back of the seat in front.

Therefore, due to the characteristics presented by each of the elements integrated in the multifunction station system which is the object of this invention and their joint cooperation a synergic saving effect is produced and the potential of the elements is increased, as it avoids the use of processing, management and communication systems in an individualised manner for each of the stations, which results in savings and improved control of each of the multifunction stations.

The essential nature of this invention is not altered by any variations in materials, form, size and arrangement of its component elements, which are described in a non-restrictive manner, with this being sufficient to proceed to its reproduction by an expert.

1. System of multifunction customer stations for application in premises available to the public or means of transport characterised in that it comprises:
a central computer or server (1), connected to
a series of multifunction stations (2) where each multifunction station comprises
a touch screen (12)
means for reproducing sound files (5) and (14),
means for supplying information from the exterior (8), (9), (10) such as
means for reading magnetic band cards (7),
a hard disk and a microprocessor,
a camera (6) and in the central computer (1) or server shared management applications reside or are connected to web applications which permit:
Viewing a menu
Selecting and ordering from a menu
payment using a card
request for and viewing of a film or live events
access to external information (e-mail, navigation with blockage of content appropriate to the premises)
connection with adult and children's games media,
holding video conferences,
Varied information on travel, hotels and bookings
Recharging mobile telephone cards

2. System of multifunction customer stations according to claim one characterised in that each of the multifunction stations is provided with means of support (13) or fixation which can be oriented or tilted.

3. Multifunction customer station system according to claim one characterised in that the means for sound reproduction of files consist of loudspeakers (5) integrated in the multifunction stations (2).

4. System of multifunction customer stations according to claim one characterised in that the means of sound reproduction are provided with a connector (14) for headphones.

5. Multifunction customer station system according to claim one characterised in that the means for supply of information from the exterior consist of at least one network connector (8) a USB connector (9) a DVD reader (10 ), means of wireless connection of the Bluetooth type (11) a HDMI connector.
